(19) United States
(12) Patent Application Publication
(10) Pub. No.: US 2019/0033083 A1
(43) Pub. Date: Jan. 31, 2019

(54) ROUTE ANALYSIS DEVICE, ROUTE ANALYSIS METHOD, AND COMPUTER-READABLE RECORDING MEDIUM

(71) Applicant: NEC Corporation, Tokyo (JP)

(72) Inventors: Yuta ASHIDA, Tokyo (JP); Itaru NISHIOKA, Tokyo (JP)

(73) Assignee: NEC Corporation, Tokyo (JP)

(21) Appl. No.: 16/073,208

(22) PCT Filed: Mar. 30, 2016
(86) PCT No.: PCT/JP2016/060537

§ 371 Date: Jul. 26, 2018

Related U.S. Application Data
(60) Provisional application No. 62/288,044, filed on Jan. 28, 2016.

(51) Int. Cl. G01C 21/34; G01C 21/36

(52) U.S. Cl. CPC G01C 21/343; G01C 21/3691

(57) ABSTRACT

A route analysis device of the present invention is for analyzing a route from a departure location to a destination. This device includes: a traffic condition prediction unit (11) that, for each of multiple future times, predicts a traffic condition in each of multiple zones that exist from the departure location to the destination; an estimation unit (12) that selects one of the traffic conditions predicted for each of the future times in accordance with the elapsed time from when prediction was performed by the traffic condition prediction unit (11), and, using the selected traffic condition, estimates a travel time that corresponds to the elapsed time in each of the zones; and a route analysis unit (13) that, using the travel times estimated for the zones, calculates the smallest value of the travel time from the departure location to the destination.

### TECHNICAL FIELD

The present invention relates to a route analysis device and a route analysis method for predicting an optimum route or travel time, and also to a computer-readable recording medium having recorded thereon a program for realizing the device or the method.

### BACKGROUND ART

In recent years, in car navigation systems, there has been demand for the ability to accurately predict the travel time required to travel from a departure location to a destination. This is because road users such as delivery personnel need to make highly precise delivery schedules. Also, the ability to make accurate time predictions improves convenience for the driver, and is also expected to reduce driver stress.

For example, Patent Document 1 discloses a system for accurately predicting such travel times. In the system disclosed in Patent Document 1, the route from a departure location to a destination is divided into multiple links, and a prediction value is prepared for the required time or the travel speed in each time slot for each link. In the system disclosed in Patent Document 1, while the user is traveling, the route travel time is calculated while comparing the current elapsed time from the departure location and the currently traveled link with the prediction values for the various time slots.

### LIST OF PRIOR ART DOCUMENTS

### Patent Document

Patent Document 1: U.S. Pat. No. 7,894,981

### DISCLOSURE OF THE INVENTION

### Problems to be Solved by the Invention

According to the system disclosed in Patent Document 1, it is thought that the precision of the travel time improves because the travel time of the set route can be calculated from prediction values for various time axes. However, the route is received from the outside, and the system disclosed in Patent Document 1 merely calculates the travel time for the received route. In other words, even if another optimum route exists between the departure location and the destination, the system disclosed in Patent Document 1 cannot calculate the travel time for that other route.

An object of the present invention is, for example, to resolve the foregoing problem and provide a route analysis device, a route analysis method, and a computer-readable recording medium that can estimate the shortest travel time from a destination to a departure location.

### Means for Solving the Problems

A route analysis device according to an aspect of the present invention for achieving the foregoing object is a device for analyzing a route from a departure location to a destination, including:

a traffic condition prediction unit that, for each of a plurality of future times, predicts a traffic condition in each of a plurality of zones that exist from the departure location to the destination;

an estimation unit that selects one of the traffic conditions predicted for each of the future times in accordance with an elapsed time from when prediction was performed by the traffic condition prediction unit, and, with use of the selected traffic condition, estimates a travel time that corresponds to the elapsed time in each of the zones; and

a route analysis unit that, with use of the travel times estimated for the zones, calculates a smallest value of a travel time from the departure location to the destination.

Also, a route analysis method according to an aspect of the present invention for achieving the foregoing object is a method for analyzing a route from a departure location to a destination, including:

(a) a step of, for each of a plurality of future times, predicting a traffic condition in each of a plurality of zones that exist from the departure location to the destination;

(b) a step of selecting one of the traffic conditions predicted for each of the future times in accordance with an elapsed time from when prediction was performed in the step (a), and, with use of the selected traffic condition, estimating a travel time that corresponds to the elapsed time in each of the zones; and

(c) a step of, with use of the travel times estimated for the zones, calculating a smallest value of a travel time from the departure location to the destination.

Furthermore, a computer-readable recording medium according to an aspect of the present invention for achieving the foregoing object is a computer-readable medium having recorded thereon a program for analysis of a route from a departure location to a destination by a computer, the program including instructions for causing the computer to execute:

(a) a step of, for each of a plurality of future times, predicting a traffic condition in each of a plurality of zones that exist from the departure location to the destination;

(b) a step of selecting one of the traffic conditions predicted for each of the future times in accordance with an elapsed time from when prediction was performed in the step (a), and, with use of the selected traffic condition, estimating a travel time that corresponds to the elapsed time in each of the zones; and

(c) a step of, with use of the travel times estimated for the zones, calculating a smallest value of a travel time from the departure location to the destination.

### Advantageous Effects of the Invention

As described above, according to the present invention, it is possible to estimate the shortest travel time from a destination to a departure location.

### BRIEF DESCRIPTION OF THE DRAWINGS

FIG. 1 is a block diagram showing a schematic configuration of a route analysis device according to a first embodiment of the present invention.

FIG. 2 is a block diagram showing a specific configuration of the route analysis device according to the first embodiment of the present invention.

FIG. 3 is a diagram showing an example of traffic conditions predicted for various future times in the first embodiment of the present invention.

FIG. 4 is a diagram for illustrating processing performed by an estimation unit according to the first embodiment of the present invention.

FIG. 5 is a flowchart showing operations performed by the route analysis device according to the first embodiment of the present invention.

FIG. 6 is a flowchart showing details of travel time estimation processing shown in FIG. 5.

FIG. 7 is a diagram illustrating step B3 shown in FIG. 6.

FIG. 8 is a diagram illustrating step B9 shown in FIG. 6.

FIG. 9 is a diagram illustrating details of travel time estimation processing executed in a second embodiment of the present invention.

FIG. 10 is a diagram illustrating calculation processing performed in the second embodiment of the present invention.

FIG. 11 is a block diagram showing an example of a computer that realizes the route analysis device according to the first or second embodiment of the present invention.

### MODES FOR CARRYING OUT THE INVENTION

### First Embodiment

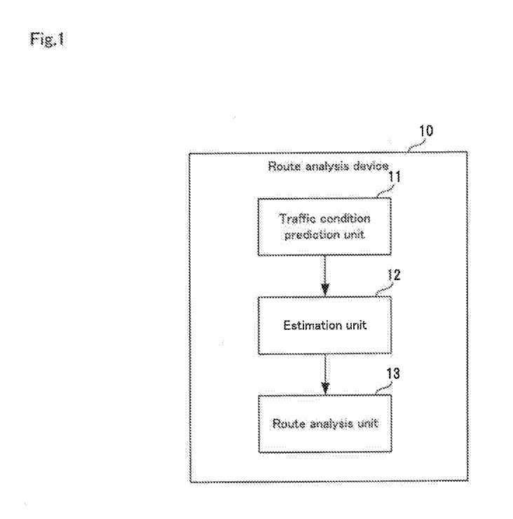

Hereinafter, a route analysis device, a route analysis method, and a program of a first embodiment of the present invention will be described with reference to FIGS. 1 to 8.

Device Configuration

First, the schematic configuration of the route analysis device of the first embodiment will be described. FIG. 1 is a block diagram showing the schematic configuration of the route analysis device according to the first embodiment of the present invention.

A route analysis device 10 of the first embodiment shown in FIG. 1 is a device for analyzing routes from a departure location to a destination. As shown in FIG. 1, the route analysis device 10 includes a traffic condition prediction unit 11, an estimation unit 12, and a route analysis unit 13.

The traffic condition prediction unit 11 predicts, for each of multiple future times, the traffic condition in each of multiple zones that exist from the departure location to the destination.

The estimation unit 12 selects one of the traffic conditions predicted for the future times in accordance with the elapsed time from the time when prediction was performed by the traffic condition prediction unit 11. The estimation unit 12 uses the selected traffic condition to estimate travel times that correspond to the elapsed time in the zones between the departure location and the destination.

The route analysis unit 13 calculates the smallest value for the travel time from the departure location to the destination using the travel times estimated for the zones between the departure location and the destination.

In this way, with the route analysis device 10, a travel time is estimated for each of the zones that make up the route from the departure location to the destination, and therefore if there are multiple routes from the departure location to the destination, a travel time is estimated for each of such routes. For this reason, according to the route analysis device 10, it is possible to estimate the shortest travel time from the destination to the departure location.

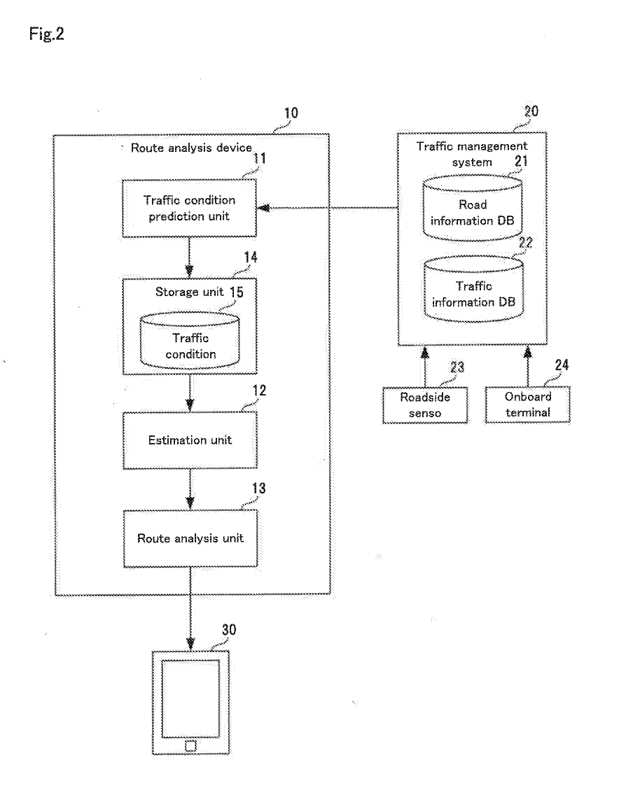

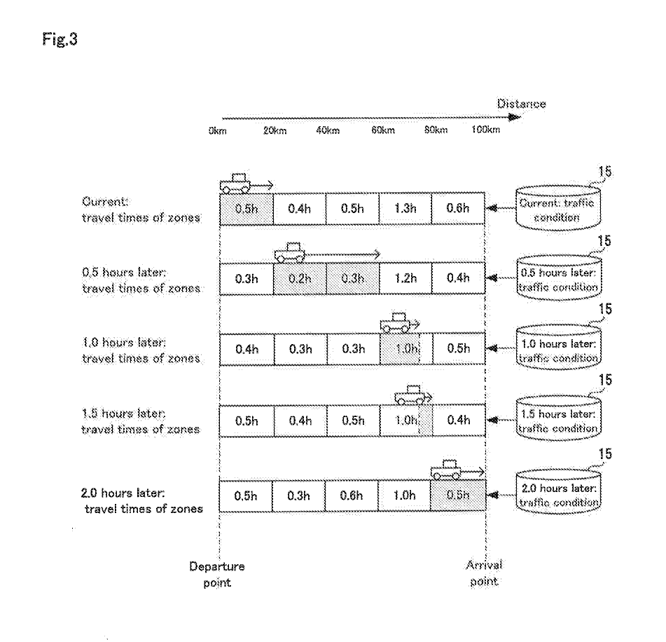

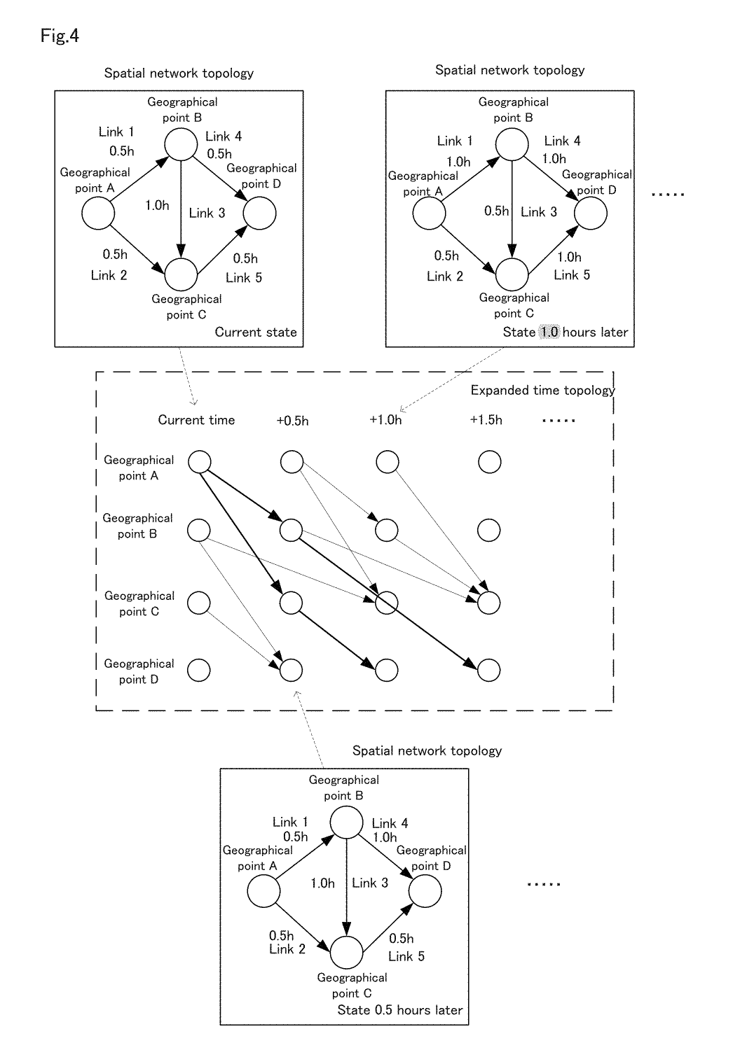

Next, the configuration of the route analysis device of the first embodiment will be described in detail with reference to FIGS. 2 to 4 as well. FIG. 2 is a block diagram showing the specific configuration of the route analysis device according to the first embodiment of the present invention. FIG. 3 is a diagram showing an example of traffic conditions predicted for various future times in the first embodiment of the present invention. FIG. 4 is a diagram for illustrating processing performed by the estimation unit according to the first embodiment of the present invention.

As shown in FIG. 2, in the first embodiment, the route analysis device 10 is connected to an external traffic management system 20 via a network. The traffic management system 20 includes a road information database (DB) 21 that stores road information, and a traffic information database (DB) 22 that stores traffic information.

Also, the road information includes road topology, number of lanes, traffic light positions, landmark (buildings, stations, parks, etc.) positions, and the like. The traffic information includes the speeds of vehicles traveling on roads, the lengths and positions of construction zones, the positions of accident sites, and the like. The traffic management system 20 also acquires sensor data from roadside sensors disposed on the sides of roads and data from onboard terminals installed in vehicles, and updates the traffic information using the acquired data.

Also, as shown in FIG. 2, in the first embodiment, the route analysis device 10 further includes a storage unit 14 in addition to the traffic condition prediction unit 11, the estimation unit 12, and the route analysis unit 13. The storage unit 14 stores traffic conditions predicted by the traffic condition prediction unit 11.

In the first embodiment, the traffic condition prediction unit 11 accesses the traffic management system 20 and acquires road information and traffic information. Then, based on the acquired road information and traffic information, the traffic condition prediction unit 11 predicts a travel time or travel speed in each zone as a traffic condition for each future time. In the first embodiment, the traffic condition prediction unit 11 also estimates the current (when prediction processing is executed) traffic condition based on the road information and the traffic information that were acquired from the traffic management system 20.

Specifically, using factors such as the day of the week, the time slot, and the weather as parameters, the traffic condition prediction unit 11 executes machine learning with use of past traffic condition data, and constructs a model. Using this model, the traffic condition prediction unit 11 predicts a travel time or a travel speed in each zone for each future time. Note that the construction of the model may be performed using existing technology, or may be performed using technology that will be newly developed in the future.

FIG. 3 shows an example of traffic conditions predicted or acquired by the traffic condition prediction unit 11. In the example in FIG. 3, the future times are set at a constant interval (e.g., 0.5 hours). The traffic condition prediction unit 11 predicts traffic conditions for 0.5 hours later, 1 hour later, 1.5 hours later, and 2.0 hours later, based on the current time. Note that the travel times shown in the example in FIG. 3 are travel times predicted for the case where the vehicle travels in the corresponding zones. Also, traffic conditions 15 shown in FIG. 3 are stored in the storage unit 14.

In the first embodiment, the estimation unit 12 first acquires the traffic conditions 15 that are stored in the storage unit 14. Specifically, the estimation unit 12 acquires the traffic condition for the time when prediction was performed (the current traffic condition), the traffic condition for 0.5 hours later, the traffic condition for 1.0 hours later, the traffic condition for 1.5 hours later, and the traffic condition for 2.0 hours later.

Next, using the acquired traffic conditions (travel times), the estimation unit 12 creates a spatial network topology of the zones for each future time, that is to say in accordance with the elapsed time from the current time, as shown in FIG. 4. In the spatial network topologies shown in FIG. 4, the zones are links that connect nodes. Also, traffic condition prediction values at corresponding times are held as link values for the links. The nodes are geographic points, including the departure location and the destination. In FIG. 4, it is assumed that a geographic point A is the departure location, a geographic point D is the destination, and a geographic point B and a geographic point C are waypoints.

Next, as shown in FIG. 4, for each future time, the estimation unit 12 maps the nodes that make up the spatial network topologies to an expanded time topology. Then, based on the expanded time topologies, the estimation unit 12 connects links, which have a length that corresponds to the travel time, from respective nodes to nodes that can connected thereto in the expanded time topology. For example, assuming that the current geographic point is the geographic point A, if the elapsed time is 0, the nodes that can be connected to the geographic point A are the geographic point B and the geographic point C, and the travel times to both of them are 0.5 h, and therefore the current geographic point A is connected with links to the geographic points B and C for 0.5 hours later. By constructing this expanded time topology, travel times that correspond to the elapsed time are estimated in each zone.

In the first embodiment, the route analysis unit 13 uses the expanded time topology constructed by the estimation unit 12 to calculate the smallest value for the travel time from the current geographic point to the destination. Also, at this time, the route analysis unit 13 can specify a route that achieves the smallest value for the travel time. In other words, using the zones that exist from the current geographic point to the destination, the route analysis unit 13 specifies a route from the current geographic point to the destination that achieves the smallest value for the travel time. Any route specification method and cost estimation method, such as Dijkstra's algorithm can be used as the route specification method and the travel time calculation method.

The route analysis unit 13 then transmits the calculated smallest value and the specified route to a user's terminal device 30. The user can therefore check the smallest travel time value and the route on a screen of the terminal device 30.

Device Operation

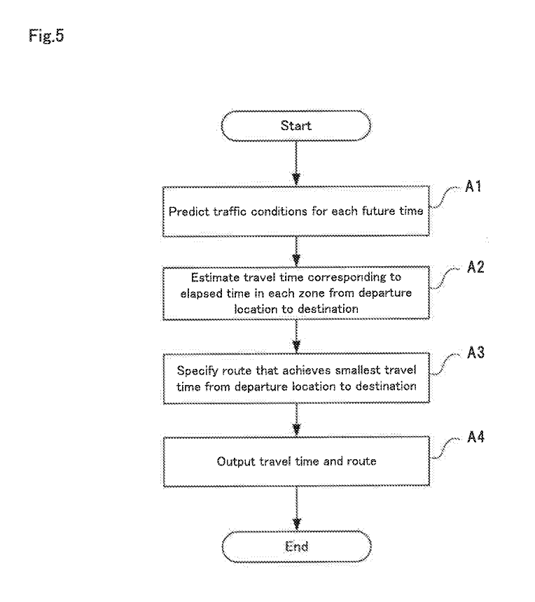

Next, operations performed by the route analysis device of the first embodiment will be described with reference to FIG. 5. FIG. 5 is a flowchart showing operations performed by the route analysis device according to the first embodiment of the present invention. FIGS. 1 to 4 will be referenced as necessary in the following description. Also, in the first embodiment, a route analysis method is implemented by causing the route analysis device to operate. Accordingly, the following description of operations performed by the route analysis device 10 will substitute for a description of the route analysis method of the present embodiment.

First, as shown in FIG. 5, when an instruction is received from the user, the traffic condition prediction unit 11 acquires road information and traffic information from the traffic management system 20, and predicts a traffic condition in each zone that exists between the departure location and the destination for each future time (step A1). The traffic condition prediction unit 11 then stores the predicted traffic conditions in the storage unit 14.

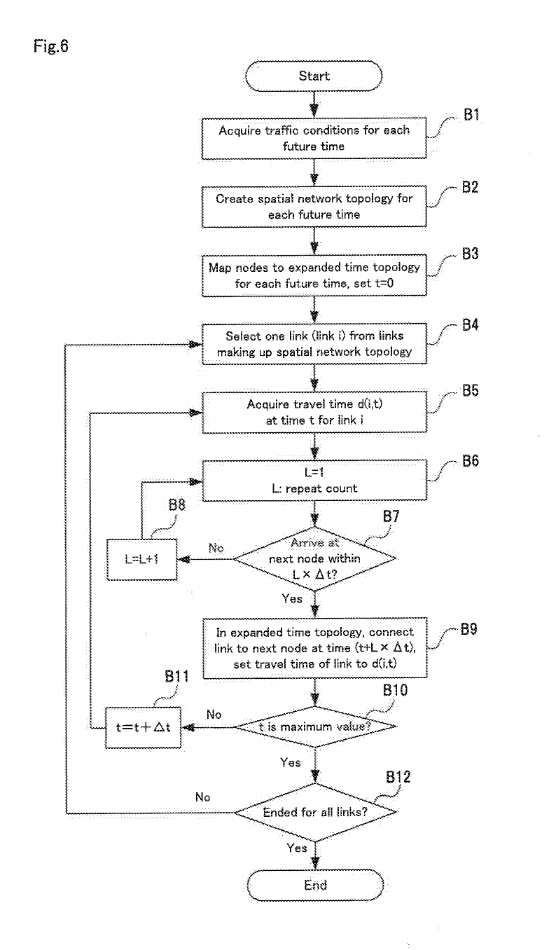

Next, the estimation unit 12 selects one of the traffic conditions predicted for the future times in accordance with the elapsed time from the time when prediction was performed in step A1, and estimates travel times that correspond to the elapsed time in the zones with use of the selected traffic condition (step A2). Note that step A2 will be described later with reference to FIG. 6.

Next, with use of the travel times estimated for the zones, the route analysis unit 13 calculates the smallest value for the travel time from the departure location to the destination, and specifies a route that achieves the smallest value for the travel time (step A3).

Thereafter, the route analysis unit 13 transmits the smallest value calculated in step A3 and the route specified in the same step A3 to the user's terminal device 30 (step A4). Due to the execution of steps A1 to A4, the user can check the smallest travel time value and the route on the screen of the terminal device 30.

Also, a configuration is possible in which the operations shown in steps A1 to A4 are performed before a user request is received, and the calculated travel time and specified route are stored in advance. In this case, travel time and route information that has been stored in advance is acquired and transmitted to the user in accordance with a request from the user. Also, a configuration is possible in which travel time calculation and route specification are performed for pairs of main geographic points before a user request is received, and, when a request is received from the user, travel time calculation and route specification are performed for the geographic point included in the request and a main geographic point. In this case, a travel time and route obtained before the request are combined with a travel time and route obtained after the request, and the combined travel times and routes are transmitted to the user.

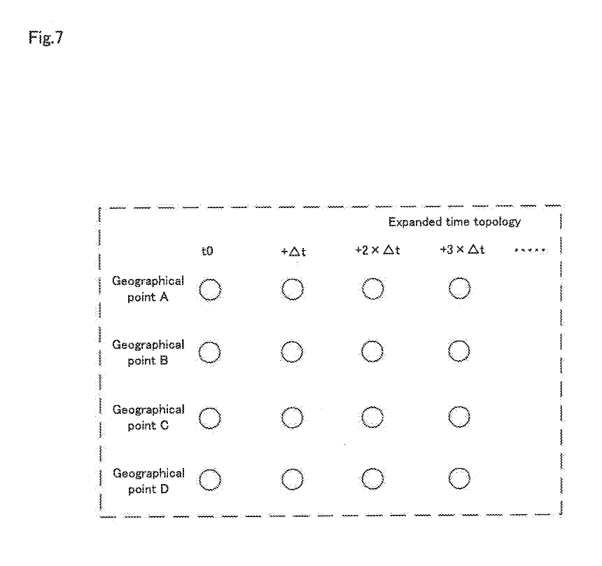

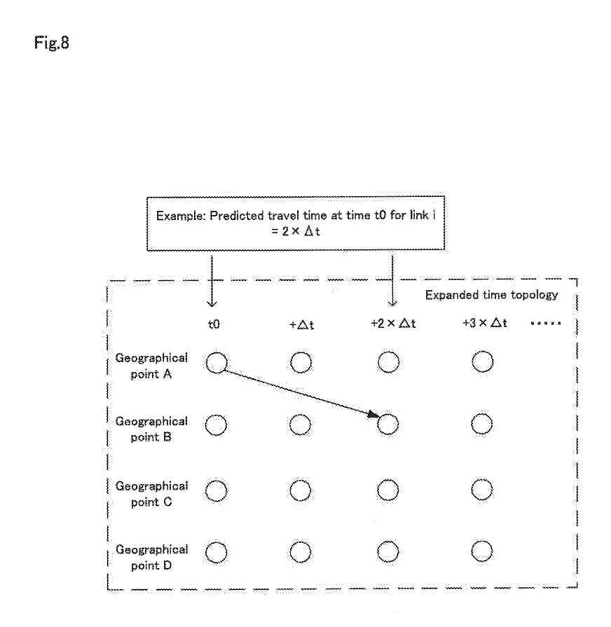

Here, the aforementioned step A2 will be described in detail with reference to FIGS. 6 to 8. FIG. 6 is a flowchart showing details of the travel time estimation processing shown in FIG. 5. FIG. 7 is a diagram illustrating step B3 shown in FIG. 6. FIG. 8 is a diagram illustrating step B9 shown in FIG. 6.

As shown in FIG. 6, first, in step A2, the estimation unit 12 acquires the traffic condition 15 for each future time from the storage unit 14 (step B1). Next, for each future time, the estimation unit 12 creates a spatial network topology (see FIG. 4) of the zones (step B2) with use of the traffic conditions (travel times) acquired in step B1.

Next, as shown in FIG. 8, for each future time, the estimation unit 12 maps the nodes that make up the spatial network topologies to an expanded time topology (step B3). Then upon mapping the nodes to the expanded time topology, the estimation unit 12 sets t to 0, and sets the calculation target time to the current time.

Next, the estimation unit 12 selects one link (link i) from among the links that make up the spatial network topology (step B4). Next, the estimation unit 12 acquires a travel time d(i,t) at the time t for the link i from the traffic condition 15 (step B5). Next, the estimation unit 12 sets a variable L, which is used as a repeat count, to 1 (step B6).

Next, based on the travel time d(i,t) acquired in step B5, the estimation unit 12 determines whether or not the vehicle on the link i will arrive at the next node (the node at the end of the link i) within the time L×Δt (step B7). Note that Δt is the interval between each future time, and is set to 0.5 hours in the example shown in FIG. 4.

If the result of the determination in step B7 is that the vehicle will not arrive, the estimation unit 12 increases the value of L by 1 (step B8), and then executes step B6 again. However, if the result of the determination in step B7 is that the vehicle will arrive, the estimation unit 12 connects a link from the node i to the next node at the time (t+L×Δt) in the expanded time topology (step B9). The estimation unit 12 also sets the link travel time to d(i,t).

Next, the estimation unit 12 determines whether or not the value of t is a maximum value (step B10), and if it is not the maximum value, the estimation unit 12 adds Δt to the value of t (step B11), and then executes step B5 again. However, if the value of t is the maximum value, the estimation unit step 12 determines whether or not processing has ended for all of the links (step B12).

If the result of the determination in step B12 is that processing has not ended for all of the links, the estimation unit 12 executes step B4 again. However, if the result of the determination in step B12 is that processing has ended for all of the links, processing performed by the estimation unit 12 is ended.

### Effects of First Embodiment

As described above, according to the first embodiment, the shortest travel time from the destination to the departure location can be estimated, and a route that achieves the shortest travel time can also be specified. Also, travel time estimation is performed based on the results of traffic condition prediction performed using traffic information and road information, and therefore the precision of the estimated travel time is high, and the specified route is optimal.

Program

It is sufficient that the program of the first embodiment is a program for causing a computer to execute steps A1 to A4 shown in FIG. 5 and steps B1 to B12 shown in FIG. 6. The route analysis device 10 and the route analysis method of the first embodiment can be realized by the program being installed in the computer and executed. In this case, a CPU (Central Processing Unit) of the computer functions as and performs processing as the traffic condition prediction unit 11, the estimation unit 12, and the route analysis unit 13.

Note that the program of the first embodiment may be executed by a computer system that is constituted by multiple computers. In this case, the computers may respectively function as the traffic condition prediction unit 11, the estimation unit 12, and the route analysis unit 13, for example.

### Second Embodiment

Next, a route analysis device, a route analysis method, and a program of a second embodiment of the present invention will be described.

First, the route analysis device of the second embodiment is configured similarly to the route analysis device 10 of the first embodiment shown in FIGS. 1 and 2. Furthermore, in the second embodiment as well, the route analysis device operates in accordance with steps A1 to A4 shown in FIG. 5.

It should be noted that the route analysis device of the second embodiment is different from the route analysis device of the first embodiment with respect to only operations performed by the traffic condition prediction unit 11 and the estimation unit 12. Specifically, in the second embodiment, the traffic condition prediction unit 11 acquires a speed in each zone as the traffic condition for each future time. Also, after selecting one of the traffic conditions, for each of the zones, the estimation unit 12 obtains a short-of-arrival distance, calculates a time required to complete the obtained short-of-arrival distance with use of the speed in the zone included in the selected traffic condition, and estimates the travel time in the zone to be the calculated time. For this reason, the second embodiment is different from the first embodiment with respect to the specific content of step A2 shown in FIG. 5 as well.

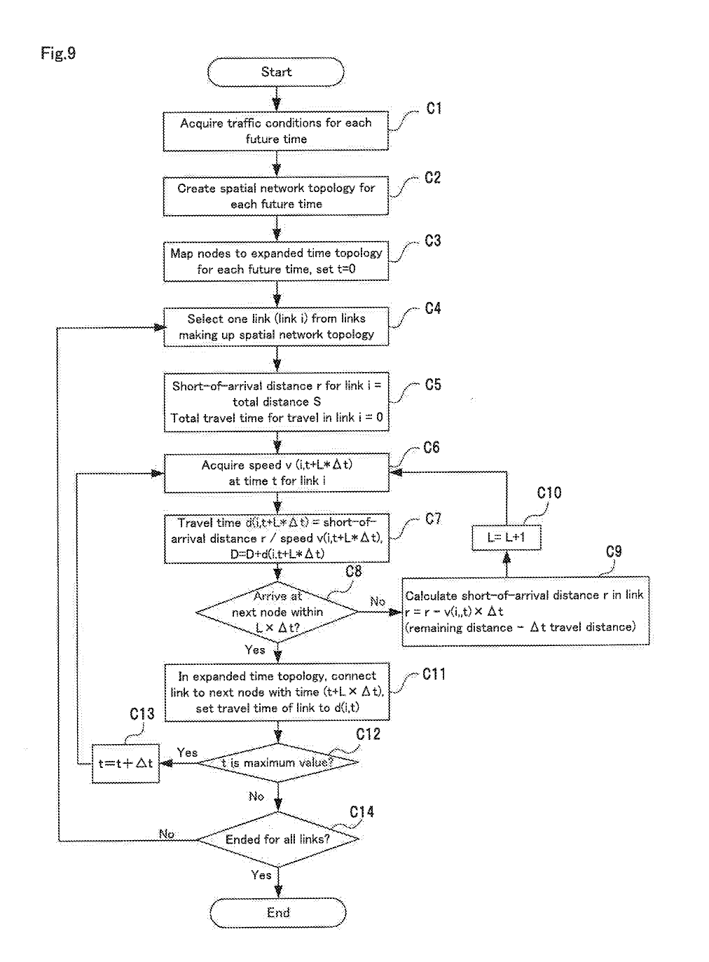

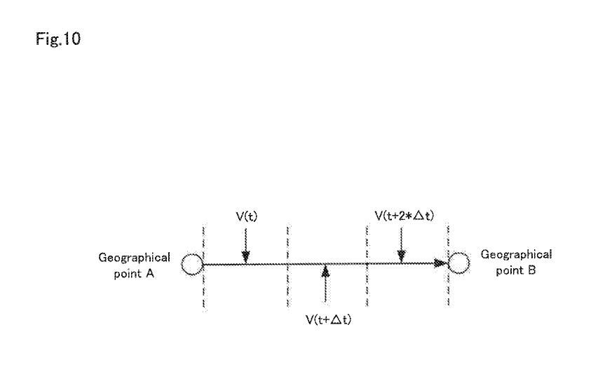

Hereinafter, differences in the second embodiment will be described in detail with reference to FIGS. 9 and 10. FIG. 9 is a diagram illustrating details of travel time estimation processing executed in the second embodiment of the present invention. FIG. 10 is a diagram illustrating calculation processing performed in the second embodiment of the present invention. Also, FIGS. 1 and 2 will also be referenced as necessary in the following description, and the reference signs used in these figures will be used as well.

As shown in FIG. 9, first, the estimation unit 12 acquires the traffic condition 15 of each of the future times from the storage unit 14 (step C1). Next, for each future time, the estimation unit 12 creates a spatial network topology (see FIG. 4) of each of the zones (step C2) with use of the traffic conditions acquired in step C1. Note that in the second embodiment, the traffic conditions are expressed with travel speeds.

Next, for each future time, the estimation unit 12 maps the nodes that make up the spatial network topologies to an expanded time topology (step C3). Then upon mapping the nodes to the expanded time topology, the estimation unit 12 sets t to 0, and sets the calculation target time to the current time.

Next, the estimation unit 12 selects one link (link i) from among the links that make up the spatial network topology (step C4). Next, based on the traffic condition 15, the estimation unit 12 sets a short-of-arrival distance r of the link i to a total distance S of the link i, sets a total travel time D required to travel the link i to 0 (zero), and sets the variable L, which is used as the repeat count, to 0 (step C5).

Next, the estimation unit 12 acquires a speed v(i,t+L×Δt) at a time t+L×Δt of the link i from the traffic condition 15 (step C6). Next, the estimation unit 12 divides the short-of-arrival distance r by the speed v(i,t+L×Δt) acquired in step C6 to calculate the travel time d(i,t+L×Δt) (step C7). Also, in step C7, the calculated travel time d(i,t+L×Δt) is added to the total travel time D required to travel the link i.

Next, based on the travel time d(i,t+L×Δt) calculated in step C7, the estimation unit 12 determines whether or not the vehicle will arrive at the next node (the node at the end of the link i) within the time L×Δt in the link i, that is to say whether or not (D<(L+1)×Δt), (step C8).

If the result of the determination in step C8 is that the vehicle will not arrive, the estimation unit 12 calculates the short-of-arrival distance r in the link. Specifically, the estimation unit 12 calculates the short-of-arrival distance r using Expression 1 below (step C9). The estimation unit 12 then adds 1 to the value of L (step C10), and then executes step C6 again.

$$short \text{-} of \text{-} arrival distance r = ( remaining distance {r}^{′} ) - ( Δ t travel distance ) = {r}^{′} - v ( i , t ) \times Δ t$$

If the result of the determination in step C8 is that the vehicle will arrive, the estimation unit 12 connects a link from the node i to the next node at the time (t+L×Δt) in the expanded time topology (step C11).

Next, the estimation unit 12 determines whether or not the value of t is a maximum value (step C12), and if it is not the maximum value, the estimation unit 12 adds Δt to the value of t (step C13), and then executes step C6 again. However, if the value of t is the maximum value, the estimation unit step 12 determines whether or not processing has ended for all of the links (step C14).

If the result of the determination in step C14 is that processing has not ended for all of the links, the estimation unit 12 executes step C4 again. However, if the result of the determination in step C14 is that processing has ended for all of the links, processing performed by the estimation unit 12 is ended.

### Effects of Second Embodiment

As described above, in the second embodiment, as shown in FIG. 10, if the vehicle cannot completely travel a link within the time Δt, the travel time of the link is calculated by setting (Δt×predicted speed) as an intermediate travel time, and then calculating the time required to completely travel the remaining portion of the link. For this reason, according to the second embodiment, consideration is given to the case where the vehicle cannot completely travel a link within the time Δt, and therefore the precision in travel time calculation is further improved over the first embodiment.

Program

It is sufficient that the program of the second embodiment is a program for causing a computer to execute steps A1 to A4 shown in FIG. 5 and steps C1 to C14 shown in FIG. 9. The route analysis device 10 and the route analysis method of the second embodiment can be realized by the program being installed in the computer and executed. In this case, a CPU (Central Processing Unit) of the computer functions as and performs processing as the traffic condition prediction unit 11, the estimation unit 12, and the route analysis unit 13.

Note that the program of the second embodiment may be executed by a computer system that is constituted by multiple computers. In this case, the computers may respectively function as the traffic condition prediction unit 11, the estimation unit 12, and the route analysis unit 13, for example.

Variations

The following describes variations of the first and second embodiments. First, when creating the expanded time topology, the estimation unit 12 may register not only a travel time for each link, but also error information (prediction error or variance, covariance (correlation) with nearby links in topology or geographic map) as well. In particular, in the second embodiment, multiple pieces of error information may be registered for a single link.

Also, in the above-described case, the route analysis unit 13 can specify a route that achieves the smallest value for the travel time even if prediction error in links accumulates to a maximum based on the error information. It should be noted that a configuration is possible in which in the case of a route that is calculated when error information has accumulated, a reliability (probability of ability to arrive by the calculated total travel time in the specified route) is calculated and presented to the user.

### APPLICATION EXAMPLES

In the present invention, the first and second embodiments described above are applicable to not only car navigation systems, but also to other applications. One example of another application is a communication network. Specifically, with the present invention, a communication network topology is subjected to time expansion based on prediction values of arrival times for packets between communication devices (routers, etc.). By calculating a lowest cost route in the expanded time topology, it is possible to obtain a network route that achieves the smallest communication delay.

In this case, the traffic condition prediction unit functions as a network condition prediction unit and predicts network conditions. Also, the estimation unit estimates transfer speeds or arrival times for packets in the network. Also, according to this aspect, it is possible to avoid the case where the amount of communication between devices increases in a certain region, particularly, the case where a communication bottleneck occurs due to a time slot or an event, and also ensure a communication route that has the smallest detour distance.

Another example of an application of the present invention is route searching when using multiple means of transportation. According to the present invention, in a network that has multiple means of transportation such as buses, trains, and airplanes, it is possible to predict travel times between terminals when using various means, thus making it possible to select the travel route that has the shortest travel time. The present invention is also useful to self-driving of automobiles.

Another example of an application of the present invention is procurement routes in supply chains. For example, the present invention is applicable to a manufacturing network that includes raw material procurement, parts manufacturing, final product manufacturing by parts assembly, product shipping, and the like. In this case, according to the present invention, it is possible to predict the time from raw material supply to product completion by predicting the amounts of time required in various chains.

Physical Configuration

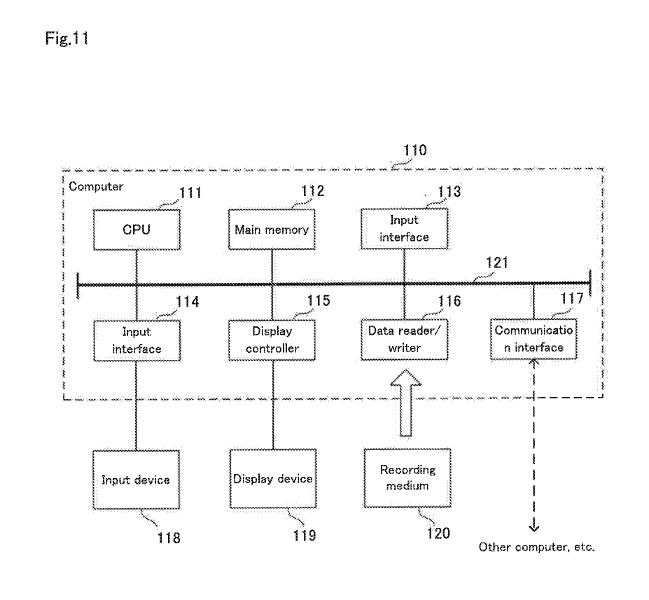

The following describes a computer that realizes the route analysis device 10 by executing the program of the first or second embodiment, with reference to FIG. 11. FIG. 11 is a block diagram showing an example of a computer that realizes the route analysis devices according to the first or second embodiment of the present invention.

As shown in FIG. 11, a computer 110 includes a CPU 111, a main memory 112, a storage device 113, an input interface 114, a display controller 115, a data reader/writer 116, and a communication interface 117. These units are connected by a bus 121 so as to be able to communicate with each other.

The CPU 111 deploys programs (code) of this embodiment, which are stored in the storage device 113, to the main memory 112, and executes various types of calculation by executing the programs in a predetermined order. The main memory 112 is typically a volatile storage device such as a DRAM (Dynamic Random Access Memory). The programs of this embodiment are provided in a state of being stored in a computer-readable recording medium 120. Note that the programs of this embodiment may be distributed over the Internet, which is accessed via the communication interface 117.

Other specific examples of the storage device 113 include a hard disk and a semiconductor storage device such as a flash memory. The input interface 114 mediates the transfer of data between the CPU 111 and an input device 118 such as a keyboard or a mouse. The display controller 115 is connected to a display device 119, and controls screens displayed by the display device 119.

The data reader/writer 116 mediates the transfer of data between the CPU 111 and the recording medium 120, and executes the readout of programs from the recording medium 120, and the writing of processing results obtained by the computer 110 to the recording medium 120. The communication interface 117 mediates the transfer of data between the CPU 111 and another computer.

Specific examples of the recording medium 120 include a general-purpose semiconductor storage device such as a CF (Compact Flash (registered trademark)) card or an SD (Secure Digital) card, a magnetic storage medium such as a Flexible Disk, and an optical storage medium such as a CD-ROM (Compact Disk Read Only Memory).

Note that the route analysis device 10 of the above embodiments can also be realized by using hardware that corresponds to the various units, instead of a computer in which a program is installed. Furthermore, a configuration is possible in which a portion of the route analysis device 10 is realized by a program, and the remaining portion is realized by hardware.

Part or all of the embodiments described above can be realized by Supplementary Notes 1 to 15 described below, but the present invention is not limited to the following descriptions.

### [Supplementary Note 1]

A route analysis device for analyzing a route from a departure location to a destination, including:

a traffic condition prediction unit that, for each of a plurality of future times, predicts a traffic condition in each of a plurality of zones that exist from the departure location to the destination;

an estimation unit that selects one of the traffic conditions predicted for each of the future times in accordance with an elapsed time from when prediction was performed by the traffic condition prediction unit, and, with use of the selected traffic condition, estimates a travel time that corresponds to the elapsed time in each of the zones; and

a route analysis unit that, with use of the travel times estimated for the zones, calculates a smallest value of a travel time from the departure location to the destination.

### [Supplementary Note 2]

The route analysis device of Supplementary Note 1, wherein the route analysis unit furthermore specifies, with use of the zones, a route from the current geographic point to the destination according to which the smallest value is achieved for the travel time.

### [Supplementary Note 3]

The route analysis device of Supplementary Note 1,

wherein the traffic condition prediction unit sets the plurality of future times with a constant interval therebetween, and, for each of the plurality of future times, predicts a speed in each of the zones that make up the route as the traffic condition, and

after selecting one of the traffic conditions, for each of the zones, the estimation unit obtains a short-of-arrival distance, calculates a time required to complete the obtained short-of-arrival distance with use of the speed in the zone included in the selected traffic condition, and estimates the travel time of the zone to be the calculated time.

### [Supplementary Note 4]

A route analysis method for analyzing a route from a departure location to a destination, including:

(a) a step of, for each of a plurality of future times, predicting a traffic condition each of a plurality of zones that exist from the departure location to the destination;

(b) a step of selecting one of the traffic conditions predicted for each of the future times in accordance with an elapsed time from when prediction was performed in the step (a), and, with use of the selected traffic condition, estimating a travel time that corresponds to the elapsed time in each of the zones; and

(c) a step of, with use of the travel times estimated for the zones, calculating a smallest value of a travel time from the departure location to the destination.

### [Supplementary Note 5]

The route analysis method of Supplementary Note 4, wherein in the step (c), a route from the current geographic point to the destination according to which the smallest value is achieved for the travel time is furthermore specified with use of the zones.

### [Supplementary Note 6]

The route analysis method of Supplementary Note 4,

wherein in the step (a), the plurality of future times are set with a constant interval therebetween, and, for each of the plurality of future times, a speed in each of the zones that make up the route is predicted as the traffic condition, and

in the step (b), after one of the traffic conditions is selected, for each of the zones, a short-of-arrival distance is obtained, a time required to complete the obtained short-of-arrival distance is calculated with use of the speed in the zone included in the selected traffic condition, and the travel time of the zone is estimated to be the calculated time.

### [Supplementary Note 7]

A computer-readable medium having recorded thereon a program for analysis of a route from a departure location to a destination by a computer, the program including instructions for causing the computer to execute:

(a) a step of, for each of a plurality of future times, predicting a traffic condition in each of a plurality of zones that exist from the departure location to the destination;

(b) a step of selecting one of the traffic conditions predicted for each of the future times in accordance with an elapsed time from when prediction was performed in the step (a), and, with use of the selected traffic condition, estimating a travel time that corresponds to the elapsed time in each of the zones; and

(c) a step of, with use of the travel times estimated for the zones, calculating a smallest value of a travel time from the departure location to the destination.

### [Supplementary Note 8]

The computer-readable recording medium of Supplementary Note 7, wherein in the step (c), a route from the current geographic point to the destination according to which the smallest value is achieved for the travel time is furthermore specified with use of the zones.

### [Supplementary Note 9]

The computer-readable recording medium of Supplementary Note 7,

wherein in the step (a), the plurality of future times are set with a constant interval therebetween, and, for each of the plurality of future times, a speed in each of the zones that make up the route is predicted as the traffic condition, and

in the step (b), after one of the traffic conditions is selected, for each of the zones, a short-of-arrival distance is obtained, a time required to complete the obtained short-of-arrival distance is calculated with use of the speed in the zone included in the selected traffic condition, and the travel time of the zone is estimated to be the calculated time.

Although the present invention has been described with reference to embodiments above, the present invention is not limited to the above embodiments. Various modifications understandable to a person skilled in the art can be made to the configuration and details of the present invention within the scope of the present invention.

This application claims priority based on U.S. Application No. 62/288,044 filed on Jan. 28, 2016, and the entire contents thereof are hereby incorporated herein.

### INDUSTRIAL APPLICABILITY

As described above, according to the present invention, it is possible to estimate the shortest travel time from a destination to a departure location. The present invention is useful to car navigation systems in particular.

### LIST OF REFERENCE SIGNS

10 Route analysis device

11 Traffic condition prediction unit

12 Estimation unit

13 Route analysis unit

14 Storage unit

15 Traffic condition

20 Traffic management system

21 Road information database

22 Traffic information database

23 Roadside sensor

24 Onboard terminal

110 Computer

111 CPU

112 Main memory

113 Storage device

114 Input interface

115 Display controller

116 Data reader/writer

117 Communication interface

118 Input device

119 Display device

120 Recording medium

121 Bus

1. A route analysis device for analyzing a route from a departure location to a destination, comprising:
a traffic condition prediction unit that, for each of a plurality of future times, predicts a traffic condition in each of a plurality of zones that exist from the departure location to the destination;
an estimation unit that selects one of the traffic conditions predicted for each of the future times in accordance with an elapsed time from when prediction was performed by the traffic condition prediction unit, and, with use of the selected traffic condition, estimates a travel time that corresponds to the elapsed time in each of the zones; and
a route analysis unit that, with use of the travel times estimated for the zones, calculates a smallest value of a travel time from the departure location to the destination.

2. The route analysis device according to claim 1,
wherein the estimation unit
furthermore acquires the traffic condition in each of the zones at a current time, and, with use of the traffic conditions in each of the zones that were predicted for each of the future times, creates a spatial network topology in which the zones are links that connect nodes for the current time and each of the future times,
maps each of the created spatial network topologies to an expanded time topology in which the nodes are set for each of the future times, and connects nodes to other nodes that are connectable thereto with a link having a length that corresponds to the traffic condition, and
with use of the links in the expanded time topology obtained by mapping, estimates a travel time that corresponds to an elapsed time from the current time in each of the zones, and
the route analysis unit calculates, with use of the travel times that were estimated using the expanded time topology obtained by mapping, a smallest value of a travel time from the departure location to the destination.

3. The route analysis device according to claim 2, wherein the route analysis unit furthermore specifies, with use of the expanded time topology obtained by mapping, a route from the a current geographic point to the destination according to which the smallest value is achieved for the travel time.

4. The route analysis device according to claim 2,
wherein the traffic condition prediction unit sets the plurality of future times with a constant interval therebetween, and, for each of the plurality of future times, predicts a speed in each of the zones that make up the route as the traffic condition, and
for each of the links in the expanded time topology obtained by mapping, the estimation unit determines whether or not a short-of-arrival distance exists, and, if the short-of-arrival distance exists in a link, the estimation unit obtains the short-of-arrival distance, calculates a time required to complete the obtained short-of-arrival distance with use of the speed predicted in the zone corresponding to the link, and estimates the travel time of the zone corresponding to the link with use of the calculated time.

5. A route analysis method for analyzing a route from a departure location to a destination, comprising:
(a) a step of, for each of a plurality of future times, predicting a traffic condition in each of a plurality of zones that exist from the departure location to the destination;
(b) a step of selecting one of the traffic conditions predicted for each of the future times in accordance with an elapsed time from when prediction was performed in the step (a), and estimating a travel time that corresponds to the elapsed time in each of the zones with use of the selected traffic condition; and
(c) a step of calculating a smallest value of a travel time from the departure location to the destination with use of the travel times estimated for the zones.

6. The route analysis method according to claim 5,
wherein in the step (b),
furthermore the traffic condition in each of the zones at a current time is acquired, and, a spatial network topology in which the zones are links that connect nodes is created for the current time and each of the future times with use of the traffic conditions in each of the zones that were predicted for each of the future times,
each of the created spatial network topologies is mapped to an expanded time topology in which the nodes are set for each of the future times, and nodes are connected to other nodes that are connectable thereto with a link having a length that corresponds to the traffic condition, and
a travel time that corresponds to an elapsed time from the current time is estimated in each of the zones with use of the links in the expanded time topology obtained by mapping, and
in the step (c), a smallest value of a travel time from the departure location to the destination is calculated with use of the travel times that were estimated using the expanded time topology obtained by mapping.

7. The route analysis method according to claim 6, wherein in the step (c), a route from a current geographic point to the destination according to which the smallest value is achieved for the travel time is furthermore specified with use of the expanded time topology obtained by mapping.

8. The route analysis method according to claim 6,
wherein in the step (a), the plurality of future times are set with a constant interval therebetween, and, for each of the plurality of future times, a speed in each of the zones that make up the route is predicted as the traffic condition, and
in the step (b), for each of the links in the expanded time topology obtained by mapping, it is determined whether or not a short-of-arrival distance exists, and, if the short-of-arrival distance exists in a link, the short-of-arrival distance is obtained, a time required to complete the obtained short-of-arrival distance is calculated with use of the speed predicted in the zone corresponding to the link, and the travel time of the zone corresponding to the link is estimated with use of the calculated time.

9. A non-transitory computer-readable medium having recorded thereon a program for analysis of a route from a departure location to a destination by a computer, the program including instructions for causing the computer to execute:
(a) a step of, for each of a plurality of future times, predicting a traffic condition in each of a plurality of zones that exist from the departure location to the destination;
(b) a step of selecting one of the traffic conditions predicted for each of the future times in accordance with an elapsed time from when prediction was performed in the step (a), and estimating a travel time that corresponds to the elapsed time in each of the zones with use of the selected traffic condition; and
(c) a step of calculating a smallest value of a travel time from the departure location to the destination with use of the travel times estimated for the zones.

10. The non-transitory computer-readable recording medium according to claim 9,
wherein in the step (b),
furthermore the traffic condition in each of the zones at a current time is acquired, and, a spatial network topology in which the zones are links that connect nodes is created for the current time and each of the future times with use of the traffic conditions in each of the zones that were predicted for each of the future times,
each of the created spatial network topologies is mapped to an expanded time topology in which the nodes are set for each of the future times, and nodes are connected to other nodes that are connectable thereto with a link having a length that corresponds to the traffic condition, and
a travel time that corresponds to an elapsed time from the current time is estimated in each of the zones with use of the links in the expanded time topology obtained by mapping, and
in the step (c), a smallest value of a travel time from the departure location to the destination is calculated with use of the travel times that were estimated using the expanded time topology obtained by mapping.

11. The non-transitory computer-readable recording medium according to claim 10, wherein in the step (c), a route from tho a current geographic point to the destination according to which the smallest value is achieved for the travel time is furthermore specified with use of the expanded time topology obtained by mapping.

12. The non-transitory computer-readable recording medium according to claim 10,
wherein in the step (a), the plurality of future times are set with a constant interval therebetween, and, for each of the plurality of future times, a speed in each of the zones that make up the route is predicted as the traffic condition, and
in the step (b), for each of the links in the expanded time topology obtained by mapping, it is determined whether or not a short-of-arrival distance exists, and, if the short-of-arrival distance exists in a link, the short-of-arrival distance is obtained, a time required to complete the obtained short-of-arrival distance is calculated with use of the speed predicted in the zone corresponding to the link, and the travel time of the zone corresponding to the link is estimated with use of the calculated time.
